(19) United States
(12) Patent Application Publication
(10) Pub. No.: US 2017/0345634 A1
(43) Pub. Date: Nov. 30, 2017

(54) AUTOMATED NANO-FLOW ELECTROSPRAY OF MICROLITERS OF SAMPLE

(71) Applicant: BATTELLE MEMORIAL INSTITUTE, Richland, WA (US)

(72) Inventors: Daniel J. Orton, Pasco, WA (US); Ronald J. Moore, West Richland, WA (US); Erin M. Baker, West Richland, WA (US)

(73) Assignee: BATTELLE MEMORIAL INSTITUTE, Richland, WA (US)

(21) Appl. No.: 15/595,334

(22) Filed: May 15, 2017

Related U.S. Application Data
(60) Provisional application No. 62/340,746, filed on May 24, 2016.

(51) Int. Cl. H01J 49/04

(52) U.S. Cl. CPC H01J 49/0445

(57) ABSTRACT

A system and method for providing sample into an electrospray device such as a mass spectrometer by providing a sample at a near constant flow through a sample delivery tube with a specified dimensionality through an emitter. These dimensions and feed rates result in higher pressures than would exist in the prior art with some of these pressures being greater than 1000 psi. This system enables increased sample throughput of up to 1200 samples per day.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy, as well as NIH Grant No. ES022190. The Government has certain rights in the invention.

### BACKGROUND OF THE INVENTION

### Field of the Invention

The invention generally relates to instrumentation for scientific and clinical discovery and more particularly to mechanisms and methodologies for automating sample loading for electrospray instruments involved in such endeavors.

### Background Information

As more and more sophisticated computing methodologies arise to analyze data produced by mass spectrometers and other instruments, a need exits to improve sample throughput in such instruments for the creation of large scale sets of data derived from such instruments. The ability to automate mass spectrometry sample injection is of great importance for studies ranging from native protein analyses to developing molecular libraries. To date, flow-injection analysis systems (FIA) have provided a solution to sample injection automation, but challenges still remain for making it adaptable to different sample types and conditions.

Various existing methodologies have limitations in and of themselves which hamper their widespread usage and application, drive up costs and still fail to address various desired performance parameters. While capable of connection with a mass spectrometer, limitations in many of the existing auto-sampler systems including a need for costly consumables, issues with sample carry over and spray stability, limited flexibility or modification, time consuming sample loading all create problems in conventional applications and implementations. In addition, high pressures can typically not be tolerated and lead to components such as syringes failing and system plugging in small diameter components such as tubing and tips which in turn leads to these high pressures can cause various other problems, including concerns that the samples will be damaged and the resulting analysis rendered useless. As a result of these issues many laboratories forgo FIA automated systems force laboratories and perform manual sample injections instead.

Manual sampling has a variety of down falls and limitations including most notably that having a human being manually prepare samples, and push them through a manual syringe into an instrument is time consuming and costly and significantly limits the number of samples that can be run despite the increased capability of the instruments to handle samples. Manually injecting samples typically involves a syringe, syringe pump, and collection of fittings to deliver the sample to the source of the mass spectrometer. Due to the increasing speed and sensitivity of currently available mass spectrometers, acquisition times from seconds to minutes are common and the time needed to clean the syringe and lines is usually longer than the actual analysis times. In addition to these problems, under typical operating conditions when the liquid flow is stopped (such as occurs for example to load cleaning solvents) the small volume at the end of the spray tip that is typically positioned proximate to a heated capillary can rapidly evaporate and precipitate, resulting in spray tip clogging and becoming unusable.

Other complications with manual injections include the relatively large sample volume needed to fill the transfer line, which can be problematic for expensive protein studies and clearing the dead volume in the transfer lines sacrifices precious sample. Viscous samples or sample plugging can increase pressures in the glass syringes and cause hairline fractures or damage. (Experience has found that typical borosilicate syringes are prone to failure at pressures greater than 1000 psi.) This threshold can be easily reached during routine use. Detecting hairline fractures that may arise can be extremely difficult at low flow rates and if not detected can have impacts on both the integrity of the system and the samples that pass through. This can lead to expensive and potentially dangerous breaks in syringes which require time and money to clean up and resolve.

Hence while mass spectrometers are continually advancing to provide increased speed and effectiveness these advancements are in many cases cannot be implemented due to front end limitations on the rates at which samples can be fed into these analytical tools. What is needed is a way to remove this bottleneck, and allow these analytical devices to operate more closely to their designed capabilities.

The present disclosure provides various examples of embodiments that are important steps towards addressing these issues and meeting these needs. Additional advantages and novel features will be set forth as follows and will be readily apparent from the descriptions and demonstrations set forth herein. Accordingly, the following descriptions should be seen as illustrative of the invention and not as limiting in any way.

### SUMMARY

In one set of embodiments a system and method for providing sample delivery into an electrospray device such as a mass spectrometer are described. In one arrangement a sample, maintained at a near constant flow by a pump, is passed through a sample delivery tube with a specified dimensionality and through an emitter with increased sample throughput and flow rate into an analytical device. In some embodiments the sample delivery tube is a capillary with an inner diameter less than 500 microns and the sample is provided through the sample delivery tube at a feed rate less than 50 micro liters per minute. In other embodiments the inner diameter and the feed rates may be varied. In some applications the diameter is less than 100 microns and in some applications the inner diameter is less than 50 microns. Feed rates may vary to be less than 100 microliters per minute, other applications the feed rate is less than 1 microliter per minute. These dimensions and feed rates result in higher pressures than would exist in the prior art with some of these pressures being greater than 50 or 100 psi and even greater than 1000 psi. However contrary to the belief of many in the prior art, these samples maintained sufficient integrity and provided useable, reliable and repeatable results. Descriptions of various embodiments and their resulting application are described in greater detail hereafter.

In one set of embodiments the flow of samples was regulated by at least one valve that controlled the flow of sample into the tubing and allowed the sample chamber to fill. In some embodiments the number and location of the various valves may be placed, configured and oriented according to the needs of the user, however in one embodiment two valves are used and are interconnected by tubing to form alternating sample loops that feed into the same sample delivery tube.

In some embodiments these systems are arranged and interconnected so as to accommodate and process more than 1,000 samples in a 24 hour period without degrading the samples and with good separation and identification of the materials sampled. The direct infusion of sample purposely at constant feed rate which can cause high pressures is taught away from the prior art systems and methods which typically include materials that cannot withstand more than about 50 psi. However, the present embodiments which perform this direct infusion at higher pressures does provide these advantages and does not cause the detrimental effects that the teachings of the prior art would suggest.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIG. 1 shows one embodiment of the present invention

FIG. 2 shows another arrangement of the present invention

FIGS. 3A and 3B show results obtained from the implementation of the disclosed method in the arrangement shown in FIGS. 1 and 2.

FIG. 4 shows exemplary structure elucidations of protein domains obtained in samples sampled through the described embodiments.

FIG. 5 shows the results from a series of samples run in on various days and their respective mappings displaying variations in the sample over time and demonstrating a need to have high sample through put.

### DETAILED DESCRIPTION OF THE INVENTION

The following pages include descriptions and examples of some of the preferred modes of deployment of the present disclosure. It will be clear from this description that the invention is not limited to these illustrated embodiments but that the invention also includes a variety of modifications and embodiments thereto. Therefore the present description should be seen as illustrative and not limiting.

Electrospray ionization has long benefitted the study of bio-molecules combined with mass spectrometry. Electrospray ionization can be gentle enough to effectively charge proteins without denaturing them. For specific compounds the requirements for stable electrospray can differ greatly in flow rate, acquisition time and instrument voltage. Mass spectrometers can run into the hundreds of thousands of dollars, but their effective use is many times limited by requiring an operator to be present at all times when data is acquired. Due to the sensitivity and the increasing speed of analysis of most modern mass spectrometers acquisition times are typically only a few minutes with directly infused samples. More time is typically taken to clean the syringe and lines than for the actual analysis, requiring an operators complete attention. To clear the dead volume, precious sample must typically be sacrificed.

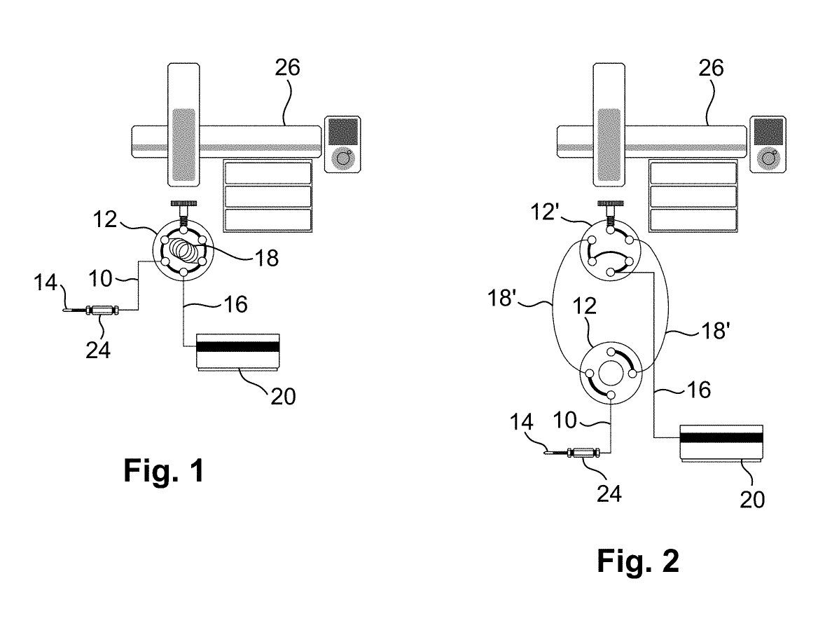

The following provides a description for automated electrospray that addresses the shortcomings of electrospray ionization for high throughput analysis. Unattended operation, even at the highest throughput options, is possible for more than two days. If analysis times are longer, the unattended operation of the device can be longer. In these described embodiments, the robustness is improved to make such throughput feasible, limiting the cost of consumables and providing more consistent results with low carry over. FIGS. 1-5 provide various illustrations and examples.

A first embodiment and associated example of use and operation is shown in FIGS. 1 and 2. Referring now first to FIG. 1, an embodiment is presented wherein a sample loop 18 having a specified dimensionality is connected to a valve 12 as a part of an automated sample delivery system that provides sample from the sample loop to an emitter 14 through a sample delivery tube 10 at a constant flow rate. This constant flow rate is provide by a pump 20 connected by take up tubing 16 to the valve 12. This pump maintains constant flow on the sample through the tube 10 and on to the emitter 14 despite fluctuations in pressure required to maintain the desired constant flow rate. In order for this to take place in an exemplary embodiment the pump 20 is equipped with a flow meter and a pressure modulator to adjust the pump output and maintain this preferred constant flow rate through the system.

Preferably, the sample delivery tube 10 is a tube having an inner diameter less than 500 microns and the sample is provided through the sample delivery tube 10 at a feed rate less than 50 micro liters per minute. A pump 20 is used to maintain pressure in the system. In other embodiments, various other set ups may be configured to include those tubes wherein the inner diameter is less than 100 microns, or even 50, 20, or even 10 microns. Similarly the feed rates may be varied to be less than 100, 1 or even 0.1 microliters per minute. The arising pressure on the samples during sample flow can typically range from between ambient to 7,250 psi. In some applications an elevated pressure of at least 1000 psi is preferred (typically between 1,000 and 2,000 psi) which is above the structural threshold of most glass syringes used in manual processes.

FIG. 2 shows an embodiment wherein two valves 12, 12′ are interconnected by sample tubing 18 to form a pair of alternating loops that feed into the same delivery tube 10. This arrangement allows for one sample loop to load from an auto sampler 26 and feed the take-up line 16 while another loop is washed and emptied to a waste container 22. A pump 20 provides pressurization to the system and maintains constant flow. This alternating arrangement has been utilized to run up to 1200 samples in a single day which is a significant advantage over the 8-12 samples that are run in a typical manual type of set up. An example of the demonstration and utilization of one embodiment is described hereafter.

### Example 1

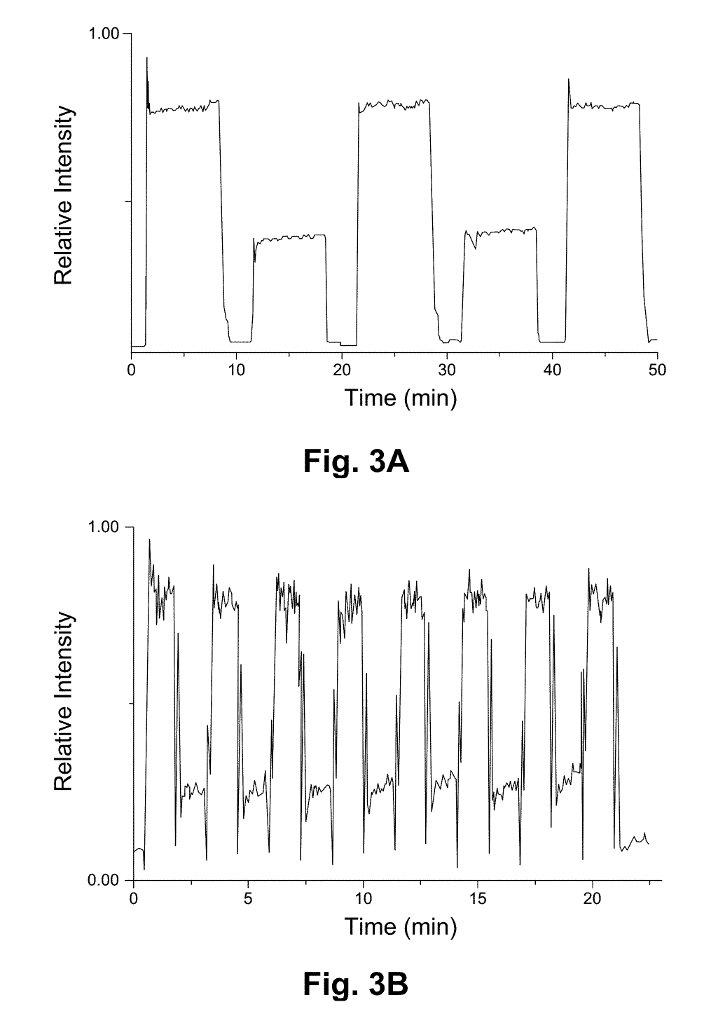

FIGS. 3A and 3B show results from the implementation of the embodiments shown in FIGS. 1 and 2 respectively, in conjunction with a mass spectrometer. In this particular experiment a dynamic load and wash Pal auto-sampler (CTC Analytics AG) equipped with a cooled (4° C.) 6 tray holder, cheminert injection valve (VICI), 1200 NanoLC pump (Agilent Technologies) and polyamide coated fused silica lines (PolyMicro), having an 10-50 μm internal diameter were arranged as shown in FIG. 1 and operated under the following conditions. The pump 20 was run at 95% aqueous 0.1% Formic in H2O (Fisher) and 5% Organic 0.1% Formic in Acetonitrile (Fisher). To provide enough back pressure to reach the 50 bar minimum preferred by the nanoLC pump a short packed column was placed between the pump and the valve. Sample loop size and LC flowrates were adjusted according to the conditions required by the samples. (In this case the loop was a stainless steel loop dimensioned to a 5 microliters sample.) Wash solvents used by the auto-sampler varied according to application to maintain sample integrity and reduce carryover. A U12 (LabJack), was used to send a contact closure to the mass spectrometer. Auto-sampler, valve, contact closure, and pump were orchestrated by LCMS.net software https://github.com/PNNL-Comp-Mass-Spec/LCMSNet which was built at Pacific Northwest National Laboratory and is available at the above mentioned address. This embodiment of the system demonstrated the capability to run several hundred samples per day, and provided continuous spray limited only by the size of sample loop and the flowrate required. The results of intensity derived from the run is shown in FIG. 3A. (while this sample embodiment was utilized a particular tray size a number of other trays or even well plates, such as a 384 well plate could have been used in such a set up)

In another embodiment an apparatus for automated electrospray was constructed according to the arrangement as set out in FIG. 2. In this embodiment a pair of valves 12, 12′ (in this case each valve being a four port cheminert valve (VICI)) were configured with sample tubing 18 to form sample loops that fed into a sample delivery tube 10 which was connected to an electrospray emitter 14 to deliver sample. In one particular arrangement the two fused silica lines 18, 18′ connected the two valves 12, 12′. The loops were each dimensioned to hold a 10 microliter sample. By alternating each loop, one loop can be used to deliver sample to the sample delivery tube 10, while the other loop can be emptied and thoroughly washed eliminating carryover. In one particular embodiment the four port valve 12 was positioned as close as possible to the electrospray interface 24 of the mass spectrometer, and electrically isolated from the motor by a PEEK collar. Valve, auto-sampler, and pump were again controlled by the LCMS.net software. Using this configuration 1200 samples per day were electrosprayed. Examples of this application are shown in FIG. 3B.

Various other samples were run and tested in these sample loading configurations to verify the accuracy and precision of the sampling techniques and to ascertain if methods and systems of the present invention had negative impacts of sample reliability or integrity, as others in the prior art would suggest. The short answer is that no such negative consequences were observed. A discussion of these tests and their results follows.

IMS-MS studies were executed with an in-house built IMS-MS instrument that coupled a 1-m ion mobility separation with an Agilent 6224 TOF MS upgraded to a 1.5 meter flight tube (providing MS resolution of ˜25,000). Ultrahigh resolution characterization of purified extracts form the two sediment types was carried out using a 12 Tesla Bruker SolariX Fourier transform ion cyclotron resonance (FT-ICR) mass spectrometer (MS) located at the Environmental Molecular Sciences Laboratory (EMSL), a Department of Energy-Office of Biological and Environmental Research national user facility in Richland, Wash., USA.

Samples (originally in methanol) were injected directly into the mass spectrometer and the ion accumulation time was optimized for all samples to account for differences in DOC (dissolved organic carbon) concentration. A standard Bruker electrospray ionization (ESI) source was used to generate negatively charged molecular ions. Whole proteins for the determination of the constant of dissociation (Kd) were filtered using a 10K spin filter (EMD Millipore) and 200 μM ammonium acetate to reduce residual sodium contamination. The samples were brought to a final concentration of 5 μm carbonic anhydrase and a variety of drug concentrations according to the estimated binding efficiency. The IMS-MS data was collected from m/z 200-14000 for each of the ligands. The Benzenesulfonamide, Ethoxzolamide, Acetazolamide, and 4-Carboxy-benzenesulfonamide were each purchased from Sigma-Aldrich (St. Louis Mo.).

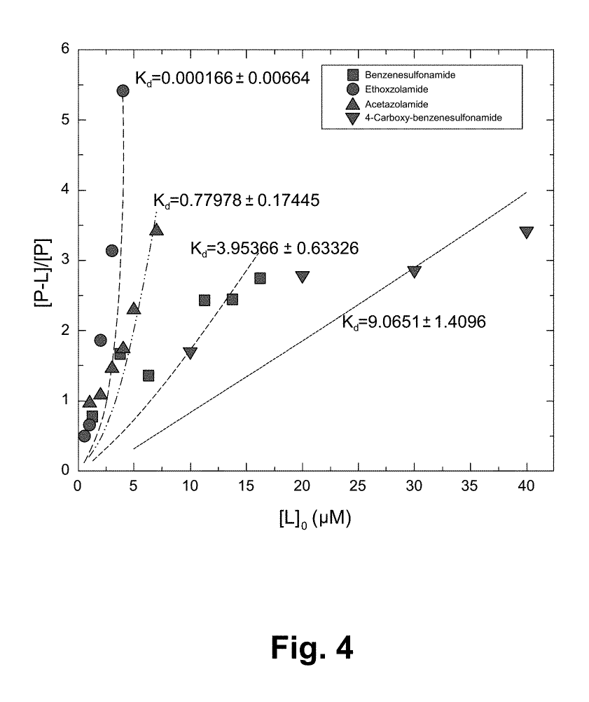

For the pH experiments, a stock solution of 50 μM ER309 in 200 mM ammonium acetate was utilized for the IMS-MS studies. To perform the pH experiments, the stock solution was diluted to 5 μM with 200 mM ammonium acetate pH adjusted using acetic acid or ammonium hydroxide to reach the desired pH of 3, 7 and 10. The IMS-MS data was collected from m/z 100-3200 for three different pHs (pHs=3, 7, and 10) to understand how the protein changed with pH. This included particularly sensitive analyses such as determination of the constant of dissociation Kd of proteins and ligands requires proteins to be sprayed in native conditions. The results from this testing is shown in FIG. 4.

Experimental conditions for the FT-ICR were as follows: needle voltage, +4.4 kV; Q1 set to 50 m/z; and the heated resistively coated glass capillary operated at 180° C. Ninety-six individual scans were averaged for each sample and internally calibrated using an organic matter homologous series separated by 14 Da (—CH2 groups). The mass measurement accuracy was less than 1 ppm for singly charged ions across a broad m/z range (100-900 m/z). The mass resolution was ˜350K at 339 m/z. Data Analysis software (BrukerDaltonik version 4.2) was used to convert raw spectra to a list of m/z values (“features”) applying FTMS peak picker with a signal-to-noise ratio (S/N) threshold set to 7 and absolute intensity threshold to the default value of 100. Chemical formulae were assigned based on the following criteria: S/N>7, and mass measurement error <1 ppm, taking into consideration the presence of C, H, O, N, S and P and excluding other elements.

The chemical character of all of the data points for each sample spectrum was evaluated on van Krevelen diagrams on the basis of their molar H:C ratios (y-axis) and molar O:C ratios (x-axis). These tests demonstrated that the samples retained their necessary integrity and identification of the major biochemical classes (i.e., lipids, proteins, lignin, carbohydrates, and condensed aromatics) of compounds present in samples was possible.

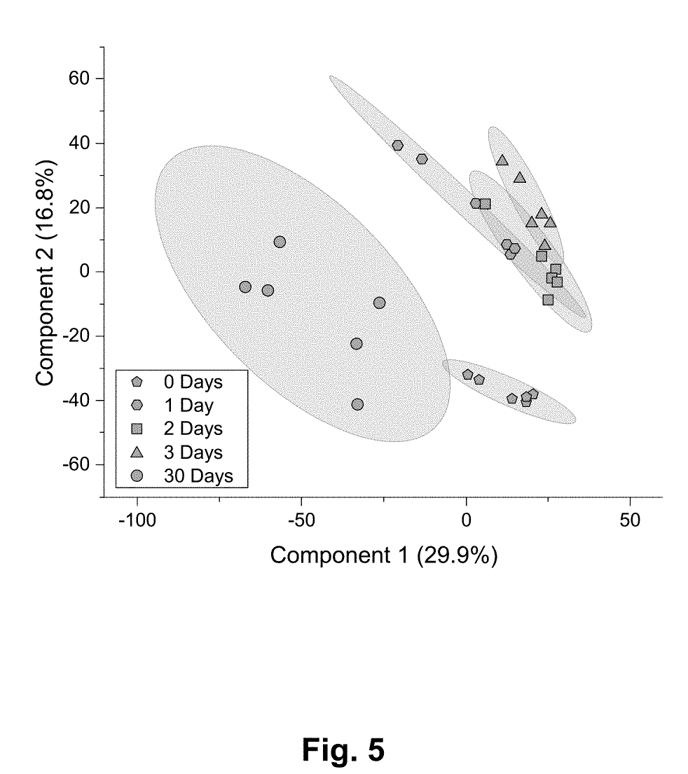

To ascertain the effects of sample degradation over time, various Peat soil samples were collected from northern Minnesota at a depth of 75 cm. The water extractable fraction was prepared in triplicates by adding 3 ml of solvent to 300 mg of bulk soil and shaking for 2 h on an Eppendorf Thermomixer in 2 mL capped glass vials. The samples were then removed from the shaker and left to stand before spinning down and pulling off the supernatant to stop the extraction. After the extraction, the supernatant from each replicate was split into three vials. The first vial was then stored in the fridge (at 4° C.), the second vial was stored in the freezer (−20° C.) whereas the third vial was further split into 5 aliquots and each aliquot was stored independently in the freezer (−20° C.). The extracts were then injected directly into the instrument (25 ul) after they were diluted in MeOH to improve ESI efficiency after T0, T1, T2, T3 and T30 days to monitor changes in organic matter composition with time. The ion accumulation time was varied to account for differences in C concentration between samples. The extraction efficiency was estimated to be around 15%. The results of the processing of these samples is shown in FIG. 5. This PCA plot shows that on day zero everything grouped together, but there were significant differences after just a day and progressively getting worse until it all fell apart by day 30. These were extracts of soil samples, that previously were only able to be run 8 in a day. There were dozens of samples that were extracted and needed to be run. Without the speed that this instrument provides not enough samples could be run in a day to show that the differences were due to actual differences in the sample and not just the changes in the samples that were happening over time.

These results show that utilizing fused silica tubing lowered the internal diameter of the system so as to reduce the diffusion of the sample plug being pushed through the system as to be inconsequential. Thorough washing of the small wetted surface area reduced the carryover to be nearly undetectable in even the most demanding of applications. LCMSnet control software also employed an error response system so that when a pump over pressured due to a plugged line all analyses were stopped, preserving precious sample. This provided further confidence that the system can run unattended overnight without great risk to sample integrity. The contact closure allows for simple deployment to mass spectrometers of all makes and models.

The described systems and method have been demonstrated to be effective in the rapid delivery of samples with an assortment of source conditions. Experiments have shown robustness in the number of samples per day and consistent performance over many days. These samples are cleanly and consistently delivered to a variety of mass spectrometers and consumables were significantly reduced, thereby reducing cost in materials and intervention by personnel. This configuration continues to be an integral lab operation that provides increased opportunities for the collection of time data from electrospray types of instruments. Looking forward, more samples will provide the opportunity to conduct larger studies with a better understanding of associated error.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A method for automated sample delivery of a sample into a mass spectrometer comprising the step of directly providing a sample at a preselected feed rate a near constant flow at pressure greater than 50 psi through a sample delivery tube with a specified dimensionality through an emitter.

2. The method of claim 1 wherein the sample delivery tube is a capillary has an inner diameter less than 500 microns.

3. The method of claim 2 wherein the sample is provided through the sample delivery tube at a feed rate less than 50 micro liters per minute.

4. The method of claim 3 where in the inner diameter is less than 100 microns.

5. The method of claim 4 where in the inner diameter is less than 50 microns.

6. The method of claim 5 wherein the feed rate is less than 100 microliters per minute.

7. The method of claim 6 wherein the feed rate is less than 1 microliter per minute.

8. The method of claim 2 wherein the sample is pressurized to at least 1000 psi.

9. The method of claim 1 wherein the flow of sample is regulated by at least one valve that regulates the filling of a sample loop by controlling the flow of sample into the capillary.

10. The method of claim 9 wherein two valves interconnected by tubing alternate to form alternating sample loops that feed into the same sample delivery tube.

11. A method for performing electrospray analysis in a mass spectrometer comprising the step of loading samples through an autosampler into an electrospray tip wherein the flow of sample to the electrospray tip exceeds 1000 psi.

12. A system for automated delivery of sample to a mass spectrometer for analysis comprising:
a sample loop having a specified dimensionality connected to a valve that provides sample from the sample loop to an emitter through a sample delivery tube, and
a pump operably connected to said valve so as to maintain constant flow of the sample through the system despite fluctuations in pressure.
